(19) United States
(12) Patent Application Publication
(10) Pub. No.: US 2020/0062077 A1
(43) Pub. Date: Feb. 27, 2020

(54) AIR CONDITIONING SYSTEM FOR A VEHICLE, GATEWAY DEVICE, METHOD FOR SETTING A PARAMETER OF AN AIR CONDITIONING DEVICE AND A COMPUTER-READABLE STORAGE MEDIUM FOR IMPLEMENTING THE METHOD

(71) Applicant: Webasto SE, Stockdorf (DE)

(72) Inventors: SEBASTIAN SONNEK, Stockdorf (DE); GÜNTHER FELLNER, Stockdorf (DE)

(21) Appl. No.: 16/611,649

(22) PCT Filed: May 4, 2018
(86) PCT No.: PCT/EP2018/061564

§ 371 Date: Nov. 7, 2019

(30) Foreign Application Priority Data
May 8, 2017 (DE) 10 2017 109 868.2

(51) Int. Cl. B60H 1/00; H04W 4/40; H04L 12/40; H04W 4/38

(52) U.S. Cl. CPC B60H 1/00657; H04W 4/40; H04W 88/16; H04W 4/38; H04L 12/40019

(57) ABSTRACT

The cabling for a subsequent installation of an auxiliary heating system in a vehicle is costly.

Therefore, an air conditioning system for a vehicle is specified including:
an air conditioning bus;
an air conditioning device, in particular a heater;
an operator control element for setting at least one target parameter, in particular a setpoint temperature value, of the air conditioning device;
a gateway device which is connected at least to the air conditioning device via the air conditioning bus. The gateway device is designed to communicate as a master on the air conditioning bus and comprises a control device for controlling the air conditioning device.

### CROSS-REFERENCE TO RELATED APPLICATIONS

This application represents the national stage entry of PCT International Patent Application No. PCT/EP2018/061564 filed on May 4, 2018 and claims priority to German Patent Application No. DE 10 2017 111 373.8 filed May 24, 2017, German Patent Application No. DE 10 2017 109 868.2 filed May 8, 2017. The contents of each of these applications are hereby incorporated by reference as if set forth in their entirety herein.

### DESCRIPTION

The disclosure relates to an air conditioning system for a vehicle, to a gateway device, to a method for setting a parameter of an air conditioning device, to a computer-readable storage medium and to a method for controlling an air conditioning system in a vehicle.

In many cases it is possible subsequently to install an independent heating system in a vehicle. A basic problem when retrofitting independent heating systems is that frequently there are no separate actuators, fans and ventilation outlets or ventilation flaps installed for the air circulation. It is, for example, possible to install a retrofittable heater in an existing heating circuit of a vehicle. In order, for example, to permit the passenger compartment of a vehicle to be heated in the shut-down state of the vehicle, it is necessary to activate the actuators, e.g. of ventilation flaps and of blowers as well as the independent heating system itself and place them in a setting which permits air circulation.

In modern vehicles, bus systems are used for communication of the various components. Therefore, for example an operator control element which is located in the passenger compartment of the vehicle can be connected to the independent heating system via a bus. The driver of the vehicle can then control the independent heating system via the operator control element. The independent heating system can be connected to an actuator in such a way that switching on the independent heating system also causes the actuator of a blower to be switched on.

A disadvantage of the described prior art is that very costly cabling is necessary. For example, cables have to be laid from the operator control element to the independent heating system and from the independent heating system to an actuator of a blower. However, the blower, like the operator control element is usually located in the passenger compartment of the vehicle in order to permit simple installation. In contrast, the independent heating system is arranged in the engine compartment. The installation of an auxiliary heating system is therefore costly. Furthermore, there is a problem in the prior art that installed independent heating systems can only be retrofitted with great difficulty.

Taking this prior art as a starting point, the object of the present disclosure is to specify an improved air conditioning system which can be easily installed in a vehicle. In addition, it is an object of the disclosure to specify an air conditioning system which reduces the necessary cable lengths. In addition, it is an object of the disclosure to specify a gateway device which addresses the disadvantages described above. Furthermore, it is an object of the disclosure to specify an improved method for setting a parameter of an air conditioning device and a corresponding computer-readable storage medium.

The object is achieved by means of an air conditioning system for a vehicle according to claim 1.

In particular, the object is achieved by means of an air conditioning system for a vehicle comprising:
an air conditioning bus,
an air conditioning device, in particular a heater,
an operator control element for setting at least one target parameter, in particular a setpoint temperature value, of the air conditioning device,
a gateway device which is connected at least to the air conditioning device via the air conditioning bus,
   wherein
   the gateway device is designed to communicate as a master on the air conditioning bus and comprises a control device for controlling the air conditioning device.

A core of the disclosure is therefore that the gateway device communicates as a master on the air conditioning bus. Since the control logic is now located in the gateway device, the air conditioning device can be correspondingly of less complex design. It is also possible for the gateway device to be arranged at a distance from the air conditioning device, e.g. in the passenger compartment of the vehicle. As a result, it is possible for further components to be connected to the air conditioning bus without a need for costly cabling leading to the air conditioning device which is embodied, for example, as a heater. The installation of an air conditioning system in a vehicle therefore becomes simpler. An air conditioning bus can be considered to be any bus which is suitable for connecting gateway devices and air conditioning devices to one another.

In one embodiment, the air conditioning device and/or the operator control element can each be embodied as a slave of the air conditioning bus.

If the air conditioning device and/or the operator control element are/is embodied as a slave, their complexity is low in terms of communication. In particular, necessary circuits are present only once on the gateway device which act as a master. A plurality of air conditioning devices, operator control elements etc. can also be operated in parallel on a bus. Retrofitting is therefore easily implementable.

In one embodiment, the gateway device can be designed to initiate a communication sequence with at least one bus user, in particular the air conditioning device and/or the operator control element.

In its function as a master, the gateway device can transmit data and/or signals to the other bus users. This does not require any previous agreement or coordination, so that the communication from the gateway device to the other bus users can be carried out particularly efficiently. So that the other bus users i.e. the slaves can communicate with one another, it may be necessary for them initially to transmit an interrogation signal to the gateway device so that the gateway device can release the air conditioning bus for communication. In other embodiments, each slave is allocated a time slot by the master, wherein each slave is designed to communicate in the time slot assigned to it.

In one embodiment, the air conditioning device can be embodied as a blower and/or fan. It is also possible that merely one blower is operated with the gateway device. It is therefore also possible to use the gateway device to control vehicle hardware of a vehicle which has already been installed.

In one embodiment, the gateway device can comprise at least one, in particular plug-in, communication device, e.g. in the form of a circuit board, for wireless communication, wherein the communication device can be designed to communicate with a mobile terminal, in particular by means of Bluetooth.

The gateway device is therefore able to receive and transmit data wirelessly via a communication device. The air conditioning bus and the devices which are connected thereto are therefore accessible to devices which are located outside the vehicle or outside the vehicle hardware.

In one embodiment, the gateway device can be designed:
to receive a target parameter from a/the mobile terminal;
to generate a control command using the target parameter; and
to transmit the control command for controlling the air conditioning device to the air conditioning device.

For example, the smartphone can transmit a setpoint temperature value as a target parameter to the gateway device which subsequently controls the air conditioning device using a control command. As a result, particularly comfortable use of the air conditioning device by a driver is made available.

In one embodiment, the gateway device can comprise an interface for transmitting and/or for receiving vehicle data from a vehicle bus, wherein the gateway device is preferably designed to control the air conditioning device using the received vehicle data.

With the described air conditioning system it is therefore possible to make available information in the form of vehicle data also to the gateway device via a vehicle bus. It is therefore possible for the control of the air conditioning device also to take into account vehicle data which are made available by components which are connected to the vehicle bus. The air conditioning system can therefore be used in a versatile way.

In one embodiment, the gateway device can be designed to communicate as a slave on the vehicle bus, e.g. a LIN-BUS. The addition of a further slave to the vehicle bus makes it possible not to have to change the communication on the vehicle bus, because it is therefore not possible for a conflict to occur with an existing master on the vehicle bus.

In one embodiment, the gateway device can comprise an, in particular plug-in (cellular), communication device for communicating in a cellular network. The gateway device can therefore also receive signals via a mobile phone network, e.g. GSM, LTE or UMTS. The gateway device can therefore be controlled from any desired location. For example, a driver can control the setpoint temperature in the vehicle from his home using his smartphone.

The (cellular) communication device can also be retrofitted e.g. in the form of a “shield”. This facilitates installation and makes it possible for a customer to be able to retrofit functionality.

In one embodiment, the (cellular) communication device can be designed to transmit status information. It is therefore also possible for communication to be executed in the direction of a smartphone, during which communication status information is transmitted. The driver of a vehicle can therefore be informed at any time about the status of the components, such as a heater, which are connected to the air conditioning bus. As a result, damage can be detected early and corresponding countermeasures can be initiated. Furthermore it is conceivable for the gateway device to transmit status information in advance to a workshop which is tasked with repairing the air conditioning system. Overall, the maintenance and monitoring of the air conditioning system are highly simplified.

In one embodiment, the gateway device can have at least one sensor, in particular which can be plugged together with a circuit board, for acquiring sensor data, in particular a pressure sensor and/or temperature sensor, wherein the gateway device can be designed to transmit the sensor data to the air conditioning device via the air conditioning bus and/or to generate control commands using the sensor data. The gateway device can therefore itself record sensor data such as e.g. the pressure or a temperature, and use said data to control the air conditioning device. It is accordingly not necessary to install any separate sensors which are connected to the air conditioning device. The complexity of the installation of the entire air conditioning system in a vehicle is therefore reduced further.

In one embodiment, the air conditioning system can comprise a second air conditioning device which can be connected to the gateway device via the air conditioning bus. It is then possible for the gateway device to transmit control commands to both air conditioning devices and therefore control both air conditioning devices. It is therefore made possible to heat a vehicle particularly efficiently. For example, both air conditioning devices can be switched on at the same time in order to permit rapid heating of the passenger compartment of the vehicle. In addition, the air conditioning devices can be arranged at different locations in the vehicle in such a way that the air flows to be distributed can pass efficiently to their location of use.

The object is also achieved by means of a gateway device according to claim 10.

In particular, the object is achieved by means of a gateway device, in particular in an air conditioning system as described above, comprising:
at least one, in particular plug-in, first communication device for (wirelessly) receiving target parameters,
a control device for controlling an air conditioning device using the target parameters, and
an in particular plug-in, second communication device for communicating on an air conditioning bus,
   wherein the gateway device is designed to communicate as a master of the air conditioning bus.

In one embodiment, the gateway device can be designed to initiate a communication sequence with another bus user, in particular a slave of the air conditioning bus.

Similar or identical advantages as to those which have already been described in conjunction with the air conditioning system are obtained.

The object is also achieved by means of a method for setting a parameter of an air conditioning device according to claim 12.

In particular, the object is achieved by means of a method for setting a parameter of an air conditioning device, in particular of a heater, comprising:
receiving at least one target parameter via a preferably cellular network at a gateway device,
processing the at least one target parameter by means of the gateway device and generating at least one control command,
setting a parameter of an air conditioning device using an air conditioning bus, wherein the parameter is determined by the gateway device on the basis of the at least one control command.

The described method is very versatile, since the target parameters can be basically transmitted by any component to the gateway device via the cellular network.

The object is also achieved by means of a computer-readable storage medium according to claim 13.

In particular, the object is achieved by means of a computer-readable storage medium which contains instructions which cause at least one processor to implement a method as described above when the instructions are executed by the at least one processor.

Similar or identical advantages to those which have been described in conjunction with the air conditioning system and the method are obtained.

Further embodiments arise from the dependent claims.

The disclosure will be described below on the basis of a plurality of exemplary embodiments which are explained in more detail by means of drawings, in which:

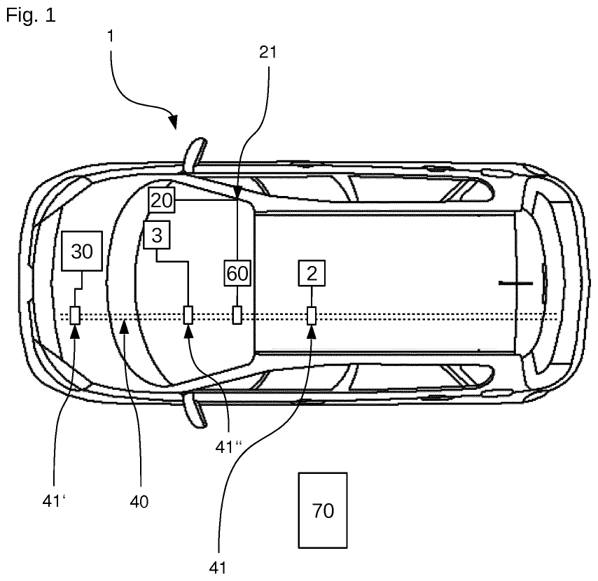

FIG. 1 shows a schematic view of a vehicle with an air conditioning bus, wherein a number of components comprising an air conditioning device are connected to the air conditioning bus;

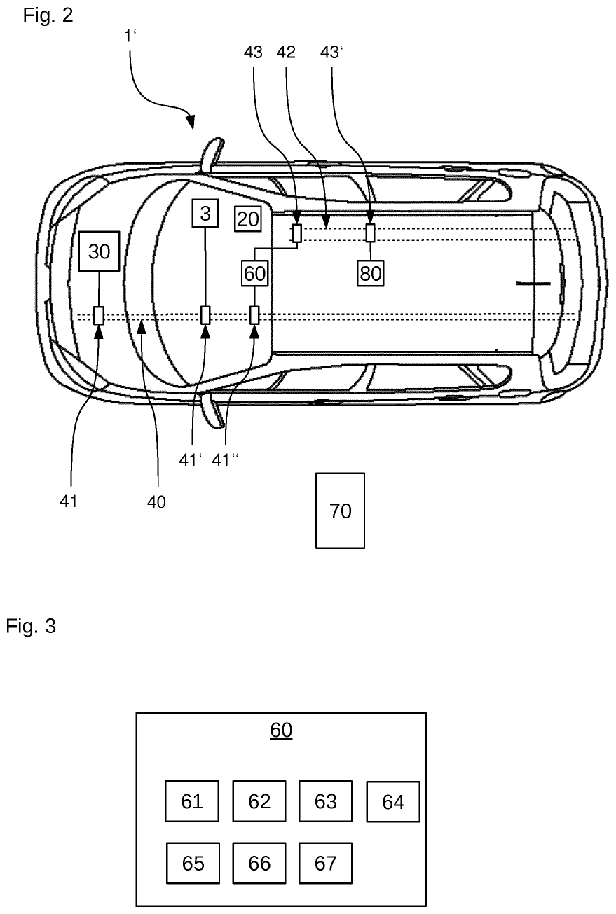

FIG. 2 shows a schematic view of a second vehicle with a vehicle bus and an air conditioning bus; and

FIG. 3 shows a schematic view of a gateway device.

In the following description, the same reference numbers are used for identical and identically acting parts.

FIG. 1 shows a vehicle 1 and a mobile terminal 70. The vehicle 1 is illustrated with the components which are important to understand the disclosure. The vehicle 1 therefore has a heater 30, a gateway device 50, an operator control element 2, a ventilation device 20 and a fan flap 3. The heater 30, the gateway device 60 and the operator control element 2 are connected to the air conditioning bus 40 via connections 41, 41′, 41″ and are connected to one another via the air conditioning bus 40. In the exemplary embodiment shown, the air conditioning bus 40 is embodied as a W-bus.

The W-bus is distinguished by the fact that a master controls the communication between a multiplicity of slaves with one another and with the master. The master can therefore initiate a communication without coordination with other components. The air conditioning bus 40 shown in FIG. 1 has a wire which is terminated at its end by means of a pull up resistance.

In the exemplary embodiment shown, the gateway device 60 is embodied as a master of the air conditioning bus 40. The heater 30, the fan flap 3 and the operator control element 2 are embodied as slaves. This means that the gateway device 60 can transmit data to the heater 30, the fan flap 3 and the operator control element 2 without being requested to do so. Those components which act as a slave on the air conditioning bus 40 must firstly enquire from the gateway device 60 whether they are allowed to execute a communication on the air conditioning bus 40.

In the exemplary embodiment of FIG. 1 the operator control element 2 is embodied as an input/output device. The driver of the vehicle 1 can input a setpoint temperature as a target temperature in the passenger compartment of the vehicle 1 via the operator control component 2. The operator control component 2 subsequently transmits the setpoint temperature as a target temperature to the gateway device 60 via the connection 41 on the air conditioning bus 40. The gateway device 60 comprises a temperature sensor which measures the temperature in the passenger compartment of the vehicle 1. If the setpoint temperature which is set by the driver does not correspond to the measured temperature value in the interior of the vehicle 1, the gateway device 60 transmits a control command to the heater 30 via the air conditioning bus 40. If the gateway device 60 has detected that the temperature in the interior of the vehicle 1 is too low, the heater 30 is made to heat. The heater 30 heats the passenger compartment of the vehicle until the gateway device 60 measures, by means of its temperature sensor, that the setpoint temperature which was input by the driver has been reached.

In order to permit efficient heating of the passenger compartment of the vehicle 1, the gateway device 60 additionally transmits control commands to the fan flap 3. The fan flap 3 comprises an actuator, e.g. a servomotor or a stepping motor, which is designed to change an adjustment angle of the fan flap 3. In the example shown, the fan flap 3 is set in such a way that the greatest possible air flow can flow through it, e.g. to 90°.

So that the heated air can flow through the fan flap 3, the gateway device 60 also transmits a pulse-width modulation signal (PWM signal) to the ventilation device 20. For this purpose, the gateway device 60 has a PWM controller, e.g. a microcontroller, which outputs a corresponding signal via a ventilation connection 21 which connects the gateway device 60 to the ventilation device 20. The ventilation device 20 has an actuator which is driven using the PWM signal. A ventilator is arranged on the actuator.

Moreover, the gateway device 60 comprises a Bluetooth module 62 (see FIG. 3) which can be used for wireless communication with a device which is located in the vicinity. For example, a Bluetooth connection can be established with a mobile terminal 70. The mobile terminal 70, which may for example be a smartphone of the driver, can be used to specify e.g. a desired temperature in the passenger compartment of the vehicle 1. After such an input, the smartphone 70 transmits a setpoint temperature value to the gateway device 60 via the Bluetooth connection. The gateway device 60 generates, as already described further above, control commands which are transmitted to the air conditioning device 30 via the air conditioning bus 40, in order to control the air conditioning device 30 in such a way that the temperature in the passenger compartment of the vehicle corresponds to the setpoint temperature value.

Moreover, the gateway device 60 can transmit status information to the mobile terminal 70 via the devices connected to the air conditioning bus 40. For example, the status information can comprise maintenance instructions, sensor data, manufacturer information or fault reports. The driver of the vehicle 1 therefore always has access to all the information which relates to the devices connected to the air conditioning bus 40.

FIG. 2 shows a second vehicle 1′ which, in contrast with the vehicle in FIG. 1, has a vehicle bus 42 in addition to an air conditioning bus 40. The heater 30 or the air conditioning device 30, the fan flap 3 and the gateway device 60 are connected to the air conditioning bus 40, as in FIG. 1. In the exemplary embodiment in FIG. 2, the air conditioning bus 40 is embodied as a two-wire bus. Of course, in the exemplary embodiment in FIG. 2 it is also possible to use a single-wire air conditioning bus 40, as is described in conjunction with FIG. 1. The gateway device 60 is embodied as a master of the air conditioning bus 40. The air conditioning device 30 and the fan flap 3 are each embodied as a slave of the air conditioning bus 40.

The gateway device 60 and an air conditioning operator control component 80 are connected to the vehicle bus 42. The gateway device 60 is embodied as a slave of the vehicle bus 42. The gateway device 60 therefore assumes a double function. On the one hand it acts as a master on the air conditioning bus 40 and, on the other hand, as a slave on the vehicle bus 42. In a further exemplary embodiment, the gateway device 60 has merely a monitoring function with respect to the vehicle bus 42 and merely monitors the data traffic on the vehicle bus 42. This means that the gateway device 60 can also neither be embodied as a master nor as a slave on the vehicle bus 42. In the illustrated exemplary embodiment in FIG. 2, the air conditioning operator control component 80 is used to receive a user input and make it available to the gateway device as vehicle data via the vehicle bus 42. The gateway device 60 processes the vehicle data of the air conditioning operator control component 80 and generates control commands which are transmitted via the air conditioning bus 40 to the air conditioning device 30 for controlling the air conditioning device 30. In the exemplary embodiment shown, the gateway device 60 is therefore used as a bridge between the air conditioning bus 40 and the vehicle bus 42.

In the exemplary embodiment shown in FIG. 2, the gateway device 60 is also designed to communicate, by means of its Bluetooth communication device 62, with a ventilation device 20. The gateway device 60 in FIG. 2 is designed to transmit control commands to the ventilation device 20 by Bluetooth. The ventilation device 20 in FIG. 2 comprises for this purpose a Bluetooth receiver unit and a computer device, for example a microcontroller, in order to covert the received control signals into PWM signals, in order to control an actuator.

Of course, the gateway device 60 can also communicate with a multiplicity of further sensors and/or actuators by Bluetooth, so that the necessary cabling in the vehicle can be significantly reduced.

In addition to the Bluetooth communication device 62, the gateway device 60 comprises a plug-in LTE module 68 for communication in an LTE network. In the exemplary embodiment in FIG. 2, in addition a smartphone 70 is provided which also has an LTE communication module, so that the smartphone 70 can communicate with the gateway device 60 via the LTE network. In particular, it is not necessary for the smartphone 70 to be located in the vicinity of the vehicle 1′. It is therefore made possible for a driver of the vehicle 1′ to control the components of the vehicle 1′ via the gateway device 60 from any desired location in the world. The driver can therefore specify a setpoint temperature which is to be regulated by the air conditioning device 30. Moreover, the driver can use his smartphone 70 to interrogate, via the gateway device 60, information which is transmitted on the air conditioning bus 40 or the vehicle bus 42. Comprehensive information about the state of the vehicle 1′ can therefore be displayed to the driver.

FIG. 3 shows a schematic illustration of the gateway device 60. The gateway device 60 comprises a computer unit 61 which is embodied e.g. as a microcontroller. The computer device 61 is designed to receive control commands via a bus communication device 63 and subsequently process them. Moreover, the gateway device 60 has a communication device 62 for wireless communication, which communication device 62 is designed to communicate by means of Bluetooth and/or to communicate with a cellular network.

The bus communication device 63 is designed to receive and transmit data via at least one bus 40, 42. Received data can be stored in a memory device 65, so that the computer device 61 can process it. In addition, the gateway device has a PWM connection by means of which a PWM signal can be transmitted to a load, e.g. the fan device 20. The computer device 61 can be used to generate the PWM signal. In addition, the gateway device 60 has a temperature sensor 66 and a pressure sensor 67. The two sensors 66 and 67 can output signals which are interpreted by the computer device 61 as a temperature or pressure and can be buffered in the memory device 65. Using the sensor data, the computer device 61 can calculate control commands which can be used to control the heater 30.

A method for installing the essential components in the vehicle 1′ will now be described once more with reference to FIG. 2. Firstly, an air conditioning device 30 has to be arranged within the vehicle 1′. Particularly the engine compartment of the vehicle 1′ is suitable for this. The air conditioning device 30 is connected to an air conditioning bus 40 via a connection 41. The gateway device 60 can subsequently be arranged in the vehicle 1′. The gateway device 60 can in principle be arranged anywhere in the vehicle 1′. However, an arrangement within the passenger compartment of the vehicle is preferred, so that installation can be easily carried out. The gateway device 60 is now connected to the air conditioning bus 40 by means of a connection 41″ and likewise connected to the vehicle bus 42 with a connection 43. By the steps alone it is possible for the gateway device 60 to control the air conditioning device 30.

In one exemplary embodiment, the gateway device 60 can also be retrofitted. In this context, it is possible to dispense with the installation of additional air conditioning devices 30 or operator control elements 2. It is then made possible that e.g. an existing air conditioning system of a vehicle 1, 1′ is monitored and/or controlled by means of the gateway device 60.

At this point it is to be noted that all the parts described above are claimed as essential to the disclosure when viewed alone and in any combination, in particular the details illustrated in the drawings. A person skilled in the art is familiar with modifications thereto. In particular, a person skilled in the art is familiar with combining the individual exemplary embodiments in any desired form.

### LIST OF REFERENCE NUMBERS

1, 1′ Vehicle
2 Operator control element
3 Fan flap
20 Ventilation device
21 Ventilation connection
30 Heater/independent heating system
40 Air conditioning bus, W-BUS
41, 41′, 41″ Connection for W-BUS
42 Vehicle bus, LIN-BUS
43, 43′ Connection for vehicle bus/LIN-BUS
55 Computer unit or microcontroller
60 Gateway device
61 Computer device/microcontroller
62 Wireless communication device
63 BUS communication device
64 PWM connection
65 Memory device
66 Temperature sensor
67 Pressure sensor
70 (Mobile) terminal
80 Air conditioning operator component

1. Air conditioning system for a vehicle, comprising:
an air conditioning bus;
an air conditioning device;
an operator control element for setting at least one target parameter of the air conditioning device;
a gateway device which is connected at least to the air conditioning device via the air conditioning bus,
wherein
the gateway device is designed to communicate as a master on the air conditioning bus and comprises a control device for controlling the air conditioning device.

2. Air conditioning system according to claim 1,
wherein
the air conditioning device and/or the operator control element are each embodied as a slave of the air conditioning bus.

3. Air conditioning system according to claim 1,
wherein
the gateway device is designed to initiate a communication sequence with at least one bus user, in particular the air conditioning device and/or the operator control element.

4. Air conditioning device according to claim 1,
wherein
the gateway device comprises at least one, in particular plug in, communication device, for wireless communication, wherein the communication device is designed to communicate with a mobile terminal.

5. Air conditioning system according to claim 5,
wherein
the gateway device is designed:
to receive a target parameter from a/the mobile terminal;
to generate a control command using the target parameter; and
to transmit the control command for controlling the air conditioning device to the air conditioning device.

6. Air conditioning system according to claim 1,
wherein
the gateway device comprises an interface for transmitting and/or for receiving vehicle data from a vehicle bus, wherein the gateway device is designed to control the air conditioning device using the received vehicle data.

7. Air conditioning system according to claim 5,
wherein
the gateway device is designed to communicate as a slave on the vehicle bus.

8. Air conditioning system according to claim 1
wherein
the gateway device comprises a communication device for communicating in a cellular network.

9. Air conditioning system according to claim 1,
wherein
the gateway device has at least one sensor for acquiring sensor data, wherein the gateway device is designed to transmit the sensor data to the air conditioning device via the air conditioning bus and/or to generate control commands using the sensor data.

10. Gateway device claim 1, comprising:
at least one first communication device for wirelessly receiving target parameters;
a control device for controlling an air conditioning device using the target parameters; and
a second communication device for communicating on an air conditioning bus;
wherein
the gateway device is designed to communicate as a master on the air conditioning bus.

11. Gateway device according to claim 10,
wherein
the gateway device is designed to initiate a communication sequence with another bus user.

12. Method for setting a parameter of an air conditioning device, comprising:
wirelessly receiving at least one target parameter via a network at a gateway device;
processing the at least one target parameter by means of the gateway device and generating at least one control command;
setting a parameter of an air conditioning device using an air conditioning bus, wherein the parameter is determined by the gateway device on the basis of the at least one control command.

13. Computer-readable storage medium which contains instructions which cause at least one processor to implement a method according to claim 12 when the instructions are executed by the at least one processor.

14. Air conditioning system according to claim 1, wherein the air conditioning device is a heater and the target parameter is a setpoint temperature value.

15. Air conditioning device according to claim 4, wherein the communication device is a plug-in communication device and the wireless communication is Bluetooth.

16. Air conditioning system according to claim 8 wherein the communication device is a plug-in cellular communication device.

17. Air conditioning system according to claim 9, wherein the at least one sensor is a pressure sensor and/or a temperature sensor and can be plugged together with a circuit board.

18. Gateway device according to claim 11, wherein the another bus user is a slave of the air conditioning bus.

19. Method according to claim 12, wherein the network is a cellular network.
